(19) United States
(12) Patent Application Publication
(10) Pub. No.: US 2005/0275337 A1
(43) Pub. Date: Dec. 15, 2005

(54) Display device

(76) Inventors: Yuuichi Kijima, Chosei (JP); Eiichi Nishiyama, Funabashi (JP); Yoshiyuki Kaneko, Hachioji (JP)

Correspondence Address: Christopher E. Chalsen;Milbank, Tweed, Hadley & McCloy LLP, 1 Chase Manhattan Plaza, New York, NY, 10005-1413, US

(21) Appl. No.: 11/145,721

(22) Filed: Jun. 6, 2005

(30) Foreign Application Priority Data
Jun. 11, 2004 (JP) 2004-173877

(51) Int. Cl. H01J 1/62; H01J 19/06

(52) U.S. Cl. 313/495; 313/311

(57) ABSTRACT

The present invention eliminates the influence attributed to a residue of an electrode forming material which is generated in a recessed portion formed in an inner surface of a back substrate thus preventing the generation of sparks whereby an image display device which possess a long lifetime and can exhibit a high-quality display can be realized. A non-displayed island-like electrode which is held at a given potential is arranged in a state that the island-like electrode surrounds a recessed portion of an opening of a through hole which is provided on an inner surface side of the back substrate.

### BACKGROUND OF THE INVENTION

1. Field of the Invention

The present invention relates to a planar image display device, and more particularly to an image display device which can reduce the generation of sparks in a display region thereof.

2. Description of the Related Art

As an image display device which exhibits the excellently high brightness and high definition, color cathode ray tubes have been popularly used conventionally.

Further, along with the recent request for the higher quality of images of information processing equipment or television broadcasting, the demand for planar displays (panel displays) which are light-weighted and require a small space while exhibiting the high brightness and the high definition has been increasing.

As typical examples, panel displays such as liquid crystal display devices, plasma display devices and the like have been put into practice.

Further, as these display devices of this type, various types of panel display devices such as a field (electron) emission type display device which enables the high brightness, an organic EL display which is characterized by low power consumption have been proposed.

Among the panel-type image display devices, Japanese Patent Laid-open 2000-251735 (patent literature 1) discloses a display device having the following constitution. That is, the display device arranges two substrates consisting of a face substrate which includes a phosphor screen and a back substrate which includes electron sources and cathode lines contiguously formed with the electron sources in a state that these two substrates face each other with a given distance therebetween, and a pressure in a display region formed between both substrates is set lower than an ambient pressure or a vacuum is created in the display region. In such a display device, a through hole is formed in the back substrate and the gap defined between the above-mentioned two substrates is evacuated directly from the through hole or by way of an exhaust pipe which is mounted on the back substrate in a state that the exhaust pipe is communicated with the through hole.

The patent literature 1 relates to a fabrication method and a fabrication device of an image display device. In the manufacture of the image display device which incorporates electron emission elements and phosphors therein and includes a hermetic vessel having an exhaust pipe and a getter, at the time of performing an aging step which allows electrons emitted from the electron emission elements to impinge on the phosphor so as to discharge an absorbed gas, a face plate of the hermetic vessel to which the phosphor is adhered is heated to promote the discharge of the absorbed gas thus fabricating the image display device which exhibits the high brightness and can perform the highly reliable image display.

Further, Japanese Patent Laid-open 2000-149788 (patent literature 2) discloses the fabrication of an evacuated hermetic vessel which is configured such that a first substrate and a second substrate are arranged with a given distance therebetween, a getter box which forms a getter accommodating chamber is provided to an outer surface of the second substrate, and the first and second substrates and the getter box are sealed using frit seals. This fabrication method is characterized in that the getter box is adhered to the second substrate using a first frit sealing material, the second substrate provided with the getter box and the first substrate are housed in the inside of the vacuum chamber and the baking and the evacuation are performed, and the first and second substrates are sealed using a second frit sealing material which has an operation temperature lower than an operation temperature of the first frit sealing material. Further, the patent literature 2 also discloses that, as advantageous effects of the fabrication method, a residual gas can be sufficiently discharged at the time of fabricating the vacuum hermetic vessel and, at the same time, a getter which can maintain a high vacuum can be accommodated in the evacuated hermetic vessel. Further, the fabrication method also has an advantageous effect that since the evacuated hermetic vessel is of a completely chipless type, there is no projections on a profile thereof whereby the evacuated hermetic vessel can obtain a compact shape.

The patent literature 2 also discloses the constitution in which a through hole which is communicated with the getter accommodating chamber of the getter box is formed in a cathode substrate and the throughhole functions as an absorption passage of the residual gas.

### SUMMARY OF THE INVENTION

In the above-mentioned related art, the formation of the cathode lines and the like on the back substrate having the electron sources, the cathode lines and the like is performed as follows. On a whole clean surface of, for example, a glass-made or ceramic-made plate which constitutes the back substrate, the above-mentioned cathode line material is formed as a film by vacuum vapor deposition, sputtering, spin coating or the like and, thereafter, desired cathode lines, for example, linear cathode lines are formed through steps such as a patterning technique, a lift-off and the like.

On the other hand, as can be clearly understood from the above-mentioned patent literatures 1, 2 and the like, conventionally, there has been adopted the constitution which forms the through hole in the back substrate and allows the exhaust pipe, the getter box and the like to be communicated with the through hole. The forming position of the through hole is, in general, set at the outermost side in the inside of the display region and does not contribute to a display pattern.

Further, since the through hole is formed before the cathode lines and the like are formed, at the time of performing the above-mentioned film forming, an opening portion of the through hole on a substrate inner surface side is configured to exhibit a recessed portion (inclined region).

However, in forming the desired pattern by removing the undesired formed film portion by the above-mentioned patterning, lift-off and the like, it is difficult to completely remove the undesired formed film portion at a hole peripheral portion of the above-mentioned recessed portion. Accordingly, there has been a drawback that a residue is generated in the portion and the residue functions as an electrode pattern to form a spark source and the display quality is damaged by sparks and the lifetime is shortened by the sparks.

FIG. 8A, FIG. 8B and FIG. 8C are cross-sectional views for explaining a portion of a manufacturing step of a conventional image display device.

As shown in FIG. 8A, on a whole surface of an inner surface 200a of a back substrate 200 which is constituted of a glass plate or a ceramic plate, for example, a cathode line coated film 300 is formed using the above-mentioned cathode line material by vacuum vapor deposition, sputtering, spin coating or the like.

The cathode line coated film 300 is formed over a planar portion of the inner surface 200a of the back substrate 200 and a recessed portion 500 of an opening of a through hole 400. The through hole 400 is communicated with an exhaust pipe (not shown in the drawing) which is fixedly secured to an outer surface 200b in a later stage.

Next, as shown in FIG. 8B, a resist film 600 is applied to the cathode line coated film 300.

Thereafter, the exposure and the developing are performed so as to form cathode lines 301 as shown in FIG. 8C.

However, in a step which removes an undesired coated film by the exposure and the developing, there arises a drawback that a residue 700 of the cathode line coated film 300 remains on the recessed portion 500.

The residue 700 is formed of the cathode line coated film 300 and hence, the residue 700 possesses the conductivity and, at the same time, the residue 700 is in a floated state in terms of potential. Accordingly, during the fabrication step or during the operation, a spark is generated between the residue 700 and other electrode such as the anode thus giving rise to drawbacks that the spark deteriorates the display quality and, at the same time, the spark becomes a cause of shortening the lifetime of the image display device.

These drawbacks arise exactly in the same manner also with respect to any constitution in which a recessed portion exists in the inner surface of the substrate irrelevant to the presence of the through hole.

Further, this drawback arises exactly in the same manner also on the face substrate side provided that the face substrate side has the constitution substantially equal to the above-mentioned constitution. The fabrication step of the face substrate having the anodes and the phosphors is a step which is substantially equal to the formation of a phosphor screen of a cathode ray tube. For example, on a whole clean surface of a glass plate or a ceramic plate which constitutes the face substrate, for example, a stripe-like BM film is formed. Thereafter, phosphor slurry is applied to a back surface side of the BM film by rotary coating thus forming a phosphor film. Then, the phosphor film is subjected to steps such as a patterning technique and a lift-off to form a desired phosphor film, for example, a stripe-like phosphor film. However, the removal of the undesired phosphor film on a hole peripheral portion of the above-mentioned recessed portion is difficult and hence, a phosphor residue is generated at such a portion. The residue functions as a phosphor pattern and hence, there also exists a possibility that the residue becomes a cause of undesired emitting of light.

Accordingly, the present invention is made to overcome the above-mentioned drawbacks of the related art, wherein the present invention can overcome the drawbacks by arranging a non-displayed island-like electrode pattern which does not contribute to a display on a peripheral portion of a recessed portion formed in an inner surface of a substrate and a potential of the island-like electrode pattern is made controllable.

Due to such a constitution, it is possible to provide an image display device which can reduce the generation of sparks, can obtain the desired high-quality display, and can prolong a lifetime.

The image display device according to the present invention is characterized by providing a non-displayed island-like electrode on an inner surface of a substrate and by holding the island-like electrode at a given potential.

Hereinafter, the representative constitutions of the image display device according to the present invention are described.

In an image display device which includes:
a face substrate which includes anodes and phosphors on an inner surface thereof;
a back substrate which includes a plurality of cathode lines and a plurality of electron sources on an inner surface thereof and faces the face substrate with a given distance therebetween;
a support body which surrounds a display region, is interposed between the face substrate and the back substrate, and holds the given distance, and
sealing materials which are respectively interposed between one end surface of the support body and the face substrate and between another end surface of the support body and the back substrate,
the improvement is characterized in that at least one of the face substrate and the back substrate includes a non-displayed island-like electrode which is held at a given potential on the inner surface thereof.

Further, the image display device according to the present invention can arrange the island-like electrode in a state that the island-like electrode surrounds a recessed portion formed in the inner surface of the substrate and the island-like electrode exhibits an approximately circular shape.

Further, the island-like electrode includes an electrode lead line or the island-like electrode is formed of a material which is equal to a material of one kind of electrode formed on the substrate.

Still further, in the image display device according to the present invention, the recessed portion can be communicated with a through hole formed in the substrate, and the through hole is communicated with an exhaust pipe or a getter accommodating portion.

Further, the island-like electrode can be formed on the back substrate and the island-like electrode can be formed of a material which is equal to a material of the cathode lines.

Due to the above-mentioned constitutions, it is possible to reduce the generation of sparks thus realizing the image display device having a long lifetime and capable of performing a high-quality display.

Here, the present invention is not limited to the above-mentioned constitutions and the constitutions of embodiments described later and various modifications can be made without departing from the technical concept of the present invention.

According to the present invention, by arranging the non-displayed island-like electrode which is held at the given potential, the non-displayed island-like electrode does not constitute a spark source and hence, it is possible to obviate the possibility of the generation of sparks whereby the image display device having the long lifetime and capable of performing the high-quality display can be obtained.

According to the present invention, by arranging the island-like electrode at a position where a residue is liable to be easily generated, even when the residue is generated, the residue does not constitute a spark source and hence, it is possible to obviate the possibility of the generation of sparks whereby the image display device having the long-lifetime and capable of performing the high-quality display can be obtained.

According to the present invention, due to a pattern formed along a peripheral shape of the recessed portion, even when a residue is present, the residue is covered with the island-like electrode and hence, the residue does not constitute a spark source. Accordingly, it is possible to obviate the possibility of the generation of sparks whereby the image display device having the long-lifetime and capable of performing the high-quality display can be obtained.

According to the present invention, it is possible to control the island-like electrode at the desired potential and hence, it is possible to obviate the possibility of the generation of sparks whereby the image display device having the long-lifetime and capable of performing the high-quality display can be obtained.

According to the present invention, the island-like electrode can be simultaneously formed with the display electrodes and hence, the operability can be enhanced and, at the same time, it is possible to obtain the image display device having the long lifetime and capable of performing the high quality display.

According to the present invention, since the through hole portion has the deep recessed portion, there exists a possibility that the residue is generated in the inside of the hole. However, due to the presence of the island-like electrode, the residue does not constitute a spark source and hence, it is possible to obviate the possibility of the generation of sparks whereby the image display device having the long-lifetime and capable of performing the high-quality display can be obtained.

According to the present invention, in view of the constitution of the image display device, there exists a large possibility that the exhaust pipe, the getter box and the like are arranged on the back substrate side and hence, it is possible to obtain a large advantageous effect in coping with the residue.

According to the present invention, the island-like electrode can be simultaneously formed with the cathode lines and hence, the operability can be enhanced, at the same time, it is possible to obtain the image display device having the long lifetime and capable of performing the high quality display.

### BRIEF DESCRIPTION OF THE DRAWING

FIG. 1 is a schematic plan view showing one embodiment of an image display device according to the present invention as viewed from a face substrate side;

FIG. 2 is an enlarged cross-sectional view taken along a line I-I in FIG. 1;

FIG. 3 is a schematic plan view showing a portion of a back substrate shown in FIG. 1 in an enlarged manner;

FIG. 4 is an enlarged cross-sectional view taken along a line II-II in FIG. 3;

FIG. 5 is a side view corresponding to FIG. 2 of another embodiment of the image display device according to the present invention;

FIG. 6 is a plan view corresponding to FIG. 3 of still another embodiment of the image display device according to the present invention;

FIG. 7 is a plan view corresponding to FIG. 3 of still further embodiment of the image display device according to the present invention; and

FIG. 8A, FIG. 8B and FIG. 8C are cross-sectional views for explaining a portion of a manufacturing step of a conventional image display device.

### DESCRIPTION OF THE PREFERED EMBODIMENTS

Hereinafter, embodiments of the present invention are explained in detail in conjunction with drawings which show these embodiments.

Here, although the explanation will be made with respect to a case in which the present invention is applied to an FED, the present invention is also applicable to other similar display devices or similar equipment.

### Embodiment 1

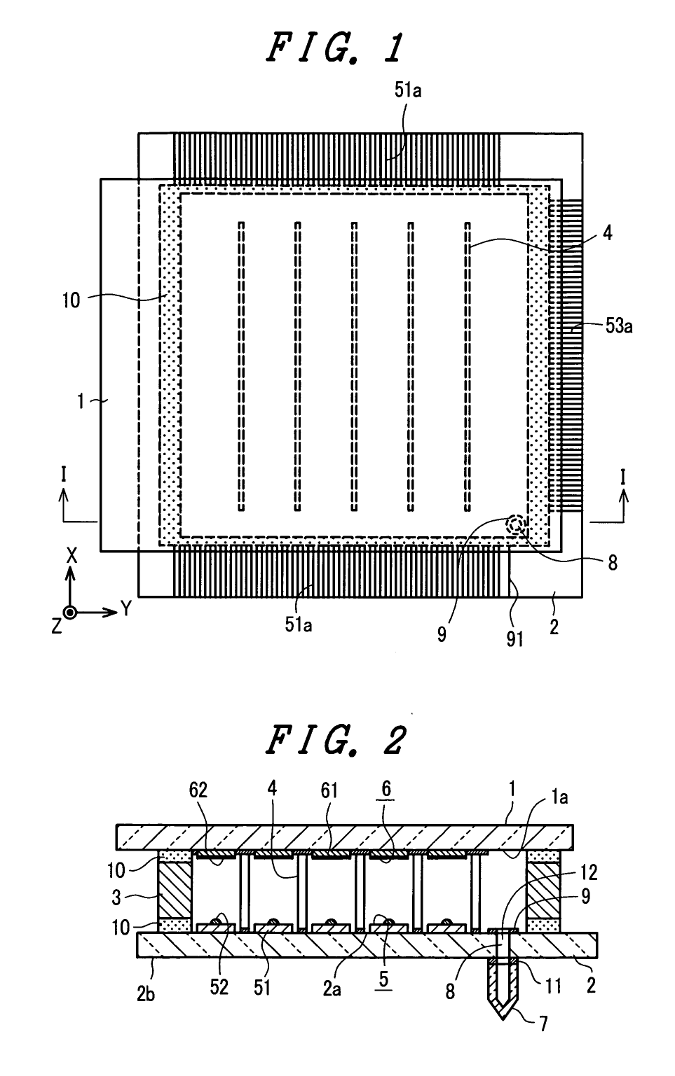

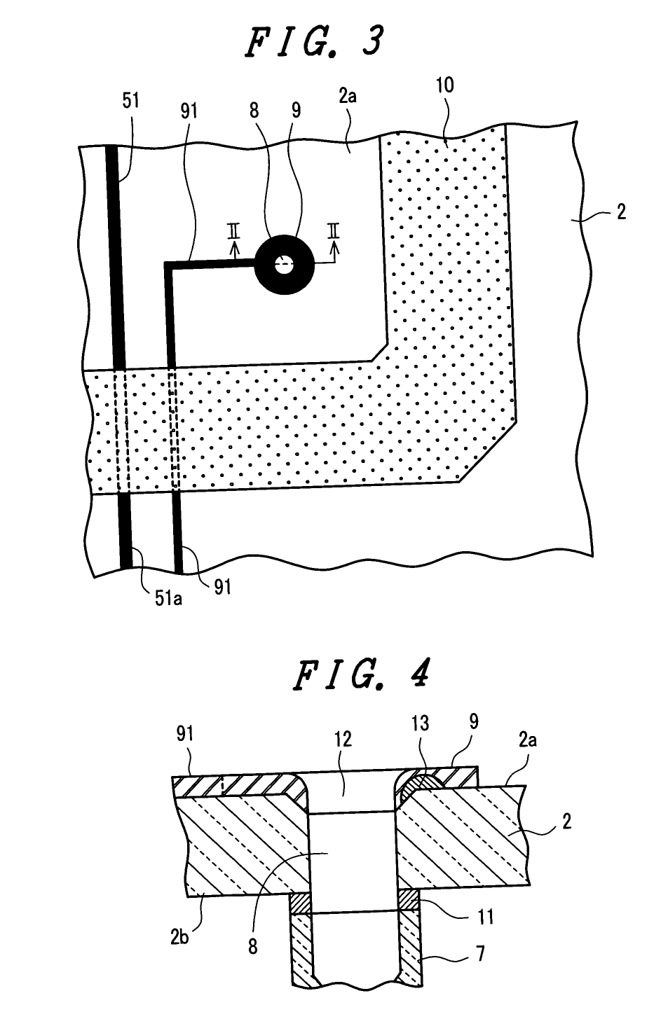

FIG. 1 to FIG. 4 are views showing an embodiment 1 of an image display device according to the present invention, wherein FIG. 1 is a schematic plan view of the image display device as viewed from a face substrate side, FIG. 2 is an enlarged cross-sectional view taken along a line I-I in FIG. 1, FIG. 3 is a schematic plan view with a portion thereof enlarged in FIG. 1, and FIG. 4 is an enlarged cross-sectional view taken along a line II-II in FIG. 3. Here, the Z direction is a stacking direction of both substrates 1, 2.

In FIG. 1 to FIG. 4, numeral 1 indicates a face substrate, numeral 2 indicates a back substrate, numeral 3 indicates a support body, numeral 4 indicates spacers, numeral 5 indicates a group of electron emission elements, numeral 51 indicates cathode lines, numeral 51a indicates cathode-line lead lines, numeral 52 indicates electron sources, numeral 6 indicates an image forming member, numeral 61 indicates phosphors, numeral 62 indicates anodes, numeral 7 indicates an exhaust pipe, numeral 8 indicates a through hole, numeral 9 indicates an island electrode, numeral 91 indicates a lead line, numeral 10 indicates a sealing material, numeral 11 indicates an adhesive material, numeral 12 indicates a recessed portion, and numeral 13 indicates a residue.

In FIG. 1 to FIG. 4, the face substrate 1 made of glass or ceramic includes the image forming member 6 on an inner surface 1a thereof which faces the back substrate 2 in an opposed manner.

The image forming member 6 includes the phosphor 61, the anode 62 which is formed of a thin film made of metal such as aluminum and is arranged to cover the phosphor 61, and a BM film (not shown in the drawing) which surrounds the phosphors 61 and the like. The image forming member 6 substantially has the same constitution as a phosphor screen of a color cathode ray tube.

On the other hand, the back substrate 2 is arranged to face the above-mentioned face substrate 1 with a given gap therebetween while sandwiching the support body 3 made of glass, for example. The back substrate 2 and the face substrate 1 are hermetically sealed using the sealing material 10 made of frit glass, for example.

Further, in a portion which is surrounded by the above-mentioned both substrates 1, 2 and the support body 3 and defines a display region, a plurality of spacers 4 which are formed of a ceramic plate, for example, are arranged and a distance between both substrates is held in cooperation with the support body 3. These spacers 4 have upper and lower ends thereof joined to both substrates using frit glass, for example.

On an inner surface 2a of the back substrate 2 which faces the above-mentioned face substrate 1, a group of electron emission elements 5 and island-like electrodes 9 and the like are formed.

This group of electron emission elements 5 is configured to include cathode lines 51, electron sources 52 which are arranged at a given pitch above the cathode line 51 and the like.

A plurality of cathode lines 51 extend in one direction (X direction) and are arranged in parallel in another direction (Y direction) on an inner surface 2a of the back substrate 2, wherein end portions of the cathode lines 51 are divided and arranged along two sides of the back substrate 2 as cathode-line lead lines 51a and are pulled out to the outside of a hermetic sealing portion.

The cathode lines 51 and the cathode-line lead lines 51a are formed of, for example, a silver (Ag) material as described above. That is, silver is applied as a film to a whole surface of an inner surface 2a of a ceramic plate which constitutes the back substrate 2 by vapor deposition, for example, and, thereafter, undesired formed film portions are removed by resist coating, patterning, lift-off and the like thus forming the cathode lines 51 and the cathode-line lead lines 51a.

Further, the electron sources 52 which are arranged on the cathode line 51 at a given pitch are formed of a diamond film, a graphite film or carbon nanotubes or the like. As a method for forming the electron sources 52, it is possible to utilize a method in which, for example, a carbon nanotube paste is printed on surfaces of the cathode lines 51 and is baked in a vacuum at a temperature of 590° C.

Further, the island-like electrode 9 is formed in an approximately circular shape of a silver material in the same manner as the cathode lines 51 and is formed at a position surrounding the recessed portion 12 formed in the opening portion of the through hole 8 which is formed in the back substrate 2. The through hole 8 is communicated with the exhaust pipe 7 which is mounted on the outer surface 2b of the back substrate 2 using an adhesive material 11. This island-like electrode 9 is a non-displayed electrode different from the above-mentioned cathode lines 51, phosphors 61 and the like.

Further, a lead line 91 is formed of a same material as the island-like electrode 9 and has one-end side thereof electrically connected to the above-mentioned island-like electrode 9 and the other-end side thereof is extended until the other-end side is arranged approximately parallel with the cathode-line lead lines 51a outside the hermetic sealing portion.

The island-like electrode 9 and the lead line 91 can be formed simultaneously with the formation of the cathode lines 51. Since the island-like electrode 9 and the lead line 91 can be formed in the same process with the cathode lines 51, it is possible to enhance the efficiency of the operational steps.

Further, by forming only the island-like electrode 9 separately, it is possible to allow the island-like electrode 9 to cover the residue 13 in the recessed portion 12 and hence, it is possible to eliminate a factor which causes sparks.

Since the potential of the island-like electrode 9 can be held at a given potential such as a ground potential or the like, for example, through the lead line 91, it is possible to prevent the island-like electrode 9 from becoming a spark source.

The potential of the island-like electrode 9 may be determined by taking the operational voltages or the like such as an anode voltage, a cathode voltage or the like into consideration. When the potential of the island-like electrode 9 is similar to the cathode voltage, it is possible to obtain an advantageous effect such as the simplification of the circuit constitution.

Further, although not shown in the drawings, the other electrodes such as control electrodes may be arranged between the group of electron emission elements 5 and the image forming members 6.

### Embodiment 2

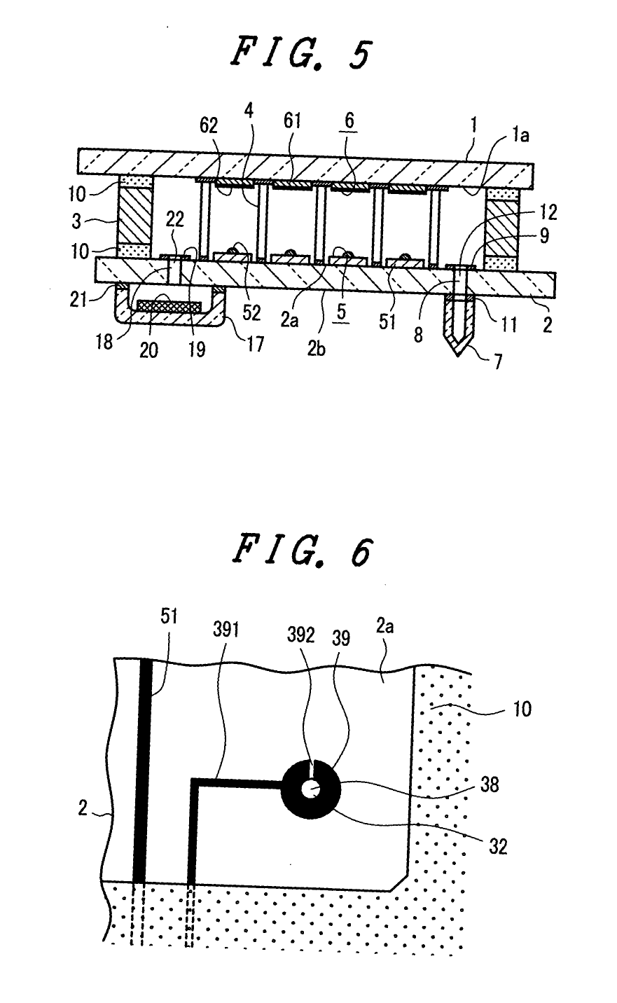

FIG. 5 is a cross-sectional view showing another embodiment of the image display device according to the present invention and corresponds to FIG. 2, wherein parts identical with the parts shown in the above-described drawings are given the same symbols.

In FIG. 5, numeral 17 indicates a getter box, numeral 18 indicates a through hole, numeral 19 indicates an island-like electrode, numeral 20 indicates a getter, numeral 21 indicates an adhesive material and numeral 22 indicates a recessed portion.

The embodiment shown in FIG. 5 has the constitution in which a plurality of (two in this embodiment) pieces of through holes 8, 18 are formed in the back substrate 2. Accordingly, a plurality of (two in this embodiment) recessed portions are also provided and a plurality of (two in this embodiment) island-like electrodes 9, 19 are provided surrounding these recessed portions.

In FIG. 5, the getter box 17 which is formed of, for example, glass and has one end thereof opened has the opened one end fixed to an outer surface 2b of the back substrate 2 using an adhesive material 21 such as frit glass. In the inside of the fixed getter box 17, the getter 20 having the known constitution is accommodated. Further, the through hole 18 which is communicated with the getter box 17 is formed in the back substrate 2. At a position surrounding the recessed portion 22 which is formed in the opening end portion of the through hole 18 on the substrate inner-surface 2a side, the island-like electrode 19 having an approximately circular shape is provided.

### Embodiment 3

FIG. 6 is a plan view showing another embodiment of the image display device according to the present invention and corresponds to FIG. 3, wherein parts identical with the parts shown in the above-described drawings are given the same symbols.

In FIG. 6, numeral 32 indicates a recessed portion, numeral 38 indicates a through hole, numeral 39 indicates an island-like electrode, numeral 391 indicates a lead line and numeral 392 indicates a notched portion of the island-like electrode 39.

The embodiment shown in FIG. 6 is configured such that at a position surrounding the recessed portion 32 of the opening portion of the through hole 38 on the substrate inner-surface 2a side, the approximately circular island-like electrode 39 having the notched portion 392 is provided.

A width of the notched portion 392 may be set such that the island-like electrode 39 is treated as one electrode. By providing such a notched portion 392, it is possible to prevent the island-like electrode 39 from generating heat.

### Embodiment 4

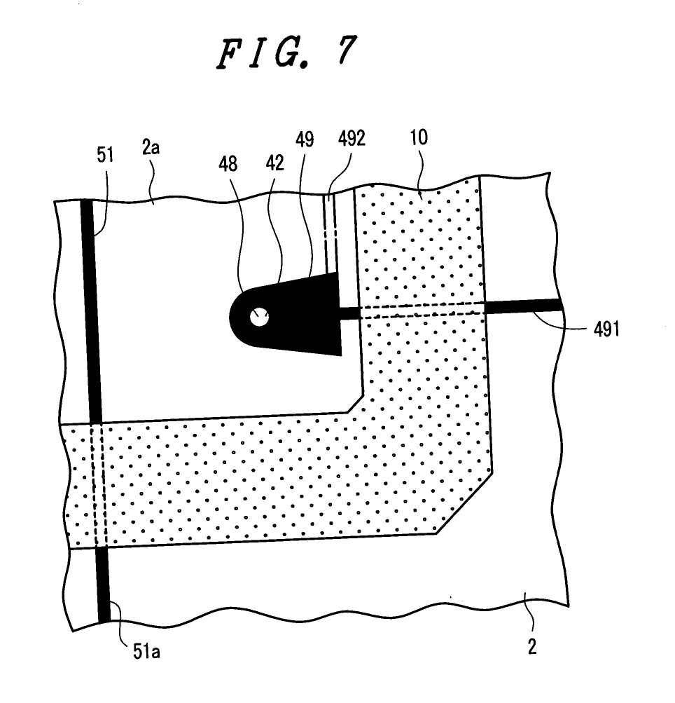

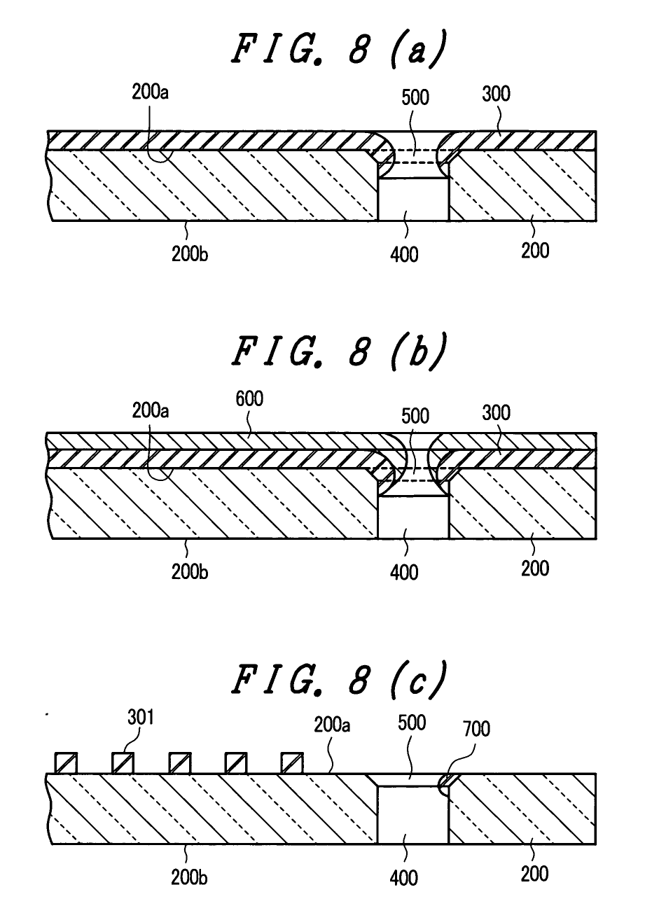

FIG. 7 is a plan view showing another embodiment of the image display device according to the present invention and corresponds to FIG. 3, wherein parts identical with the parts shown in the above-mentioned drawings are given the same symbols.

In FIG. 7, numeral 42 indicates a recessed portion, numeral 48 indicates a through hole, numeral 49 indicates an island-like electrode, numeral 491 indicates a lead line and numeral 492 indicates a relay line.

The embodiment shown in FIG. 7 is configured such that at a position which surrounds the recessed portion 42 of the opening portion of the through hole 48 at the substrate inner surface 2a side, an approximately temple-bell-like island-like electrode 49 is provided and the lead line 491 which is connected to the island-like electrode 49 is pulled out to an end surface side different from a cathode-line lead line 51a. Further, the relay line 492 indicated by an imaginary line is, in the constitution where another island-like electrode not shown in the drawing is present at another portion on the same plane, connected with such another island-like electrode and is made of the same material as the island-like electrode 49 and the lead line 491.

In such a constitution, by arranging the lead line 491 on the end surface different from the end surface for the cathode-line lead line 51a, the supply of electricity to the island-like electrode is facilitated. Further, by arranging the relay line 492, it is possible to reduce the number of power supply terminals. Still further, it is possible to utilize this island-like electrode 49 as a positioning pattern in fabrication steps.

1. An image display device comprising:
a face substrate which includes anodes and phosphors on an inner surface thereof;
a back substrate which includes a plurality of cathode lines and a plurality of electron sources on an inner surface thereof and faces the face substrate with a given distance therebetween;
a support body which surrounds a display region, is interposed between the face substrate and the back substrate, and holds the given distance, and
sealing materials which are respectively interposed between one end surface of the support body and the face substrate and between another end surface of the support body and the back substrate, wherein
at least one of the face substrate and the back substrate includes an island-like electrode not used for display and given a fixed potential, and
the island-like electrode includes an electrode lead line extending through said sealing materials.

2. An image display device according to claim 1, wherein the island-like electrode is arranged in a state that the island-like electrode surrounds a recessed portion formed in the inner surface of the face substrate or the back substrate.

3. An image display device according to claim 1, wherein the island-like electrode exhibits an approximately circular shape.

4. (canceled)

5. An image display device according to claim 1, wherein the island-like electrode is formed of the same material as one kind of electrode formed on the substrate.

6. An image display device according to claim 2, wherein the recessed portion is communicated with a through hole formed in the substrate.

7. An image display device according to claim 6, wherein the through hole is communicated with an exhaust pipe mounted on the substrate.

8. An image display device according to claim 6, wherein the through hole is communicated with a getter accommodating portion mounted on the substrate.

9. An image display device according to claim 1, wherein the island-like electrode is mounted on the back substrate.

10. An image display device according to claim 9, wherein the island-like electrode is formed of the same material as the cathode lines formed on the back substrate.

11. An image display device according to claim 1, said island-like electrode being formed in said back substrate.

12. An image display device according to claim 1, said island-like electrode is either given a fixed potential or covered by a conductor of a fixed potential.

13. An image display device according to claim 1, wherein there are more than one island-like electrodes, and said island-like electrodes are either all given a fixed potential or all covered by a conductor of a fixed potential.
